(19) United States
(12) Patent Application Publication
(10) Pub. No.: US 2005/0044260 A1
(43) Pub. Date: Feb. 24, 2005

(54) SYSTEM AND METHOD FOR DELIVERY OF BROADBAND CONTENT

(75) Inventors: Nathan S. Abramson, Cambridge, MA (US); William Wittenberg, Lexington, MA (US)

Correspondence Address: LAHIVE & COCKFIELD, LLP., 28 STATE STREET, BOSTON, MA, 02109, US

(73) Assignee: MAVEN NETWORKS, INC., Cambridge, MA (US)

(21) Appl. No.: 10/708,260

(22) Filed: Feb. 20, 2004

Related U.S. Application Data
(63) Continuation-in-part of application No. 10/637,924, filed on Aug. 8, 2003.
(60) Provisional application No. 60/493,965, filed on Aug. 8, 2003.
(60) Provisional application No. 60/533,713, filed on Dec. 30, 2003.

(51) Int. Cl. G06F 15/16; G06F 15/173

(52) U.S. Cl. 709/233; 709/235; 709/230; 709/232; 709/228; 709/224

(57) ABSTRACT

A system for efficiently downloading a page of broadband content includes a mass storage device, a bandwidth measurement device, a download manager, and a presentation manager. The bandwidth measurement device determines the bandwidth of a network connection over which the content file will be downloaded by the system. The download manager retrieves and stores in the mass storage device a portion of the content file, the size of the portion determined responsive to the bandwidth determination made by the bandwidth measurement device. The presentation manager retrieves the stored portion of the content file from mass storage and displays the portion using a standard media player application.

### CROSS REFERENCE TO RELATED APPLICATIONS

This application is a continuation-in-part of U.S. patent application Ser. No. 10/637,924, entitled “SYSTEM AND METHOD OF INTEGRATING VIDEO CONTENT WITH INTERACTIVE ELEMENTS”, and filed Aug. 8, 2003, the contents of which are incorporated herein by reference.

This application also claims the benefit of U.S. Provisional Patent Application Ser. No. 60/493,965, entitled “SYSTEM AND METHOD OF INTEGRATING VIDEO CONTENT WITH INTERACTIVE ELEMENTS”, filed Aug. 8, 2003, and U.S. Provisional Patent Application Ser. No. 60/533,713, entitled “SYSTEM AND METHOD FOR DELIVERY OF BROADBAND CONTENT”, filed Dec. 30, 2003. The entire content of both patent applications is hereby incorporated by reference.

### FIELD OF INVENTION

The present invention relates delivery of content and, more particularly, to systems and methods for efficiently delivering broadband content.

### BACKGROUND OF THE INVENTION

The worldwide network of computers commonly known as the “Internet” has two compelling advantages over traditional media as a selling tool. Those advantages are the immediacy of the media and the interactivity of the media. A website is able to present to a potential customer photos, audio clips, and streaming video that exhibit products and services to a potential customer. In addition, a website may receive input from the user to see other aspects of a proposed product or service or to place an order.

Unfortunately, photos, audio clips, and moving video images are large and typically require long download times. This can be inconvenient for a user waiting for such content to be retrieved from the hosting server. More troublesome, however, is that many entities are charged based on the bandwidth used. Transfer of large files can be very expensive, especially if the user does not access the downloaded content. However, transferring content files only when selected by a user sacrifices the immediacy of visual and audio content and is unacceptable.

Thus, it would be desirable to have systems and methods capable of efficiently downloading such content.

### BRIEF SUMMARY OF THE INVENTION

The present invention provides a system and associated methods for efficiently downloading and displaying video content to a user and integrating with the video content one or more interactive elements that are displayed semi-transparently over the video. Selected portions of content files are downloaded to a client node. The size of the selected portions is selected such that, upon indication by a user that display of a particular content file is desired, the remainder of the content file can be downloaded before the display of the downloaded portion is complete. The user, therefore, experiences no interruption in service despite the fact that content files have only been partially downloaded.

In one aspect the present invention relates to a system for efficiently downloading a page of broadband content that includes at least one content file. The system includes a mass storage device, a bandwidth measurement device, a download manager, and a presentation manager. The bandwidth measurement device determines the bandwidth of a network connection over which the content file will be downloaded by the system. In some embodiments the bandwidth measurement device is a timer that determines how long the content file will take to download. The download manager retrieves and stores in the mass storage device a portion of the content file, the size of the portion determined responsive to the bandwidth determination made by the bandwidth measurement device. The presentation manager retrieves the stored portion of the content file from mass storage and displays the portion using a standard media player application, such as the Windows Media Player. The download manager downloads the remainder of the content file in response to the presentation manager beginning display of the content file. In some embodiments the size of the portion of the content file is selected so that the remainder of the content file can be downloaded before the portion is completely presented by the presentation manager. In some embodiments the mass storage device comprises a redundant array of independent disks or a network storage solution.

In some of these embodiments the bandwidth measurement device and the download manager comprise a single process. In others of these embodiments the download manager, the presentation manager, and the bandwidth measurement device are threaded processes, ActiveX controls, or JAVA applets.

In another aspect, the present invention relates to a method for efficiently downloading a page of broadband content that includes at least one content file. A content file is retrieved. Retrieval of the content file is terminated before the entire content file is retrieved and the retrieved portion is stored in a mass storage device. The stored portion of the content file is read from the mass storage device and is displayed using a standard media player, such as Windows Media Player. In response to the display of the portion of the content file, the remainder of the content file is retrieved.

In some of these embodiments, retrieval of the content file is terminated responsive to a determination of the bandwidth of the network connection over which the content file is downloaded. In others of these embodiments the content file is retrieved over a peer-to-peer network or a multicast network. The remainder of the content file can also be downloaded over a peer-to-peer network or a multicast network, without regard to the type of network used to download the portion of the content file. In others of these embodiments, the remainder of the content file is downloaded while the standard media player displays the stored portion of the content file.

In another aspect the present invention relates to an article of manufacture having embodied thereon computer-readable program means for efficiently downloading a page of broadband content that includes a first content file and a second content file. In this aspect of the invention the article of manufacture has embodied thereon: computer-readable program means for retrieving a content file; computer-readable program means for terminating retrieval of the content file before the entire content file is retrieved; computer-readable program means for storing the retrieved portion of the content file in a mass storage device; computer-readable program means for reading the portion of the content file from the mass storage device; computer-readable program means for displaying with a standard media player application the read portion of the content file; and computer-readable program means for retrieving the remainder of the content file.

In still another aspect the present invention relates to a system for efficiently downloading video content represented by at least one content file and integrating interactivity with the video content. The system includes a mass storage device, a bandwidth measurement device, a download manager, and a presentation manager. The bandwidth measurement device determines the bandwidth of a network connection over which a content file is downloaded. The download manager retrieves and stores in the mass storage device a portion of a first file representing video content. The size of the portion of the first file retrieved by the download manager is responsive to the determination of the bandwidth of the network connection made by the bandwidth measurement device. The download manager also retrieves and stores in the mass storage device a second file comprising an interactive element. The presentation manager (i) retrieves the portion of the first file from mass storage, (ii) displays with a standard media player application video content represented by the portion of the first file, (iii) retrieves the second file from mass storage, and (iv) displays with a standard media player application the interactive element semi-transparently over the video content. The download manager downloads the remainder of the first file in response to the presentation manager displaying the stored portion of the first file.

In some of these embodiments, the mass storage device is a redundant array of independent disks or a network storage solution. In others of these embodiments the bandwidth measurement device is a timer. In still other embodiments the download manager and the bandwidth measurement device are a single process. In some of these embodiments, the download manager is a threaded process, an ActiveX control, or a JAVA applet.

In another aspect, the present invention relates to a method for efficiently downloading video content that includes at least one content file and integrating interactivity with the video content. A content file is retrieved. Retrieval of the content file is terminated before the entire content file is retrieved and the retrieved portion is stored in a mass storage device. A second file is retrieved and stored in the mass storage device. The second file represents an interactive element. The stored portion of the content file is read from the mass storage device and is displayed using a standard media player, such as Windows Media Player. The second file is retrieved from the mass storage device and displayed semi-transparently over the displayed video content. In response to the display of the portion of the content file, the remainder of the content file is retrieved.

In some of these embodiments, retrieval of the content file is terminated responsive to a determination of the bandwidth of the network connection over which the content file is downloaded. In others of these embodiments the content file is retrieved over a peer-to-peer network or a multicast network. The remainder of the content file can also be downloaded over a peer-to-peer network or a multicast network, without regard to the type of network used to download the portion of the content file. In others of these embodiments, the remainder of the content file is downloaded while the standard media player displays the stored portion of the content file.

In another aspect the present invention relates to an article of manufacture having embodied thereon computer-readable program means for efficiently downloading video content and integrating interactivity with the video content. In this aspect of the invention the article of manufacture has embodied thereon: computer-readable program means for retrieving a content file; computer-readable program means for terminating retrieval of the content file before the entire content file is retrieved; computer-readable program means for storing the retrieved portion of the content file in a mass storage device; computer-readable program means for reading the portion of the content file from the mass storage device; computer-readable program means for displaying with a standard media player application the read portion of the content file; computer-readable program means for retrieving a second file from mass storage representing an interactive element; computer-readable program means for displaying with a standard media player application semi-transparently over the displayed video content an interactive element represented by the second file; and computer-readable program means for retrieving the remainder of the content file.

In another aspect the present invention relates to a system for efficiently downloading broadband content. The system includes a mass storage device, a download manager and a presentation manager. The download manager retrieves and stores in the mass storage device a portion of the content file. The size of the portion of the content file that is downloaded may be predetermined or provided by the user. The presentation manager retrieves the stored portion of the content file from mass storage and displays the portion using a standard media player application, such as the Windows Media Player. The download manager downloads the remainder of the content file in response to the presentation manager beginning display of the content file. In some embodiments the mass storage device comprises a redundant array of independent disks or a network storage solution.

In some of these embodiments the download manager and the presentation manager are threaded processes, ActiveX controls, or JAVA applets.

In still another aspect, the present invention relates to a method for efficiently downloading broadband content. A content file is retrieved. Retrieval of the content file is terminated before the entire content file is retrieved and the retrieved portion is stored in a mass storage device. The stored portion of the content file is read from the mass storage device and is displayed using a standard media player, such as Windows Media Player. In response to the display of the portion of the content file, the remainder of the content file is retrieved.

In some of these embodiments, the content file is retrieved over a peer-to-peer network or a multicast network. The remainder of the content file can also be downloaded over a peer-to-peer network or a multicast network, without regard to the type of network used to download the portion of the content file. In others of these embodiments, the remainder of the content file is downloaded while the standard media player displays the stored portion of the content file.

### BRIEF DESCRIPTION OF THE DRAWINGS

The invention is pointed out with particularity in the appended claims. The advantages of the inventions described above, together with further advantages of the invention, may be better understood by referring to the following description in conjunction with the accompanying drawings, in which:

FIG. 1 is a block diagram of one embodiment of a client-server system in which the present invention can be used;

FIGS. 2A and 2B are block diagrams of embodiments of computers useful as a client node;

FIG. 3 depicts a block diagram of an embodiment of a client node useful in the present invention;

FIG. 4 is a flowchart depicting one embodiment of the steps taken to download a channel of content; and

FIG. 5 is a flowchart depicting one embodiment of the steps to be taken to efficiently download content.

### DETAILED DESCRIPTION OF THE INVENTION

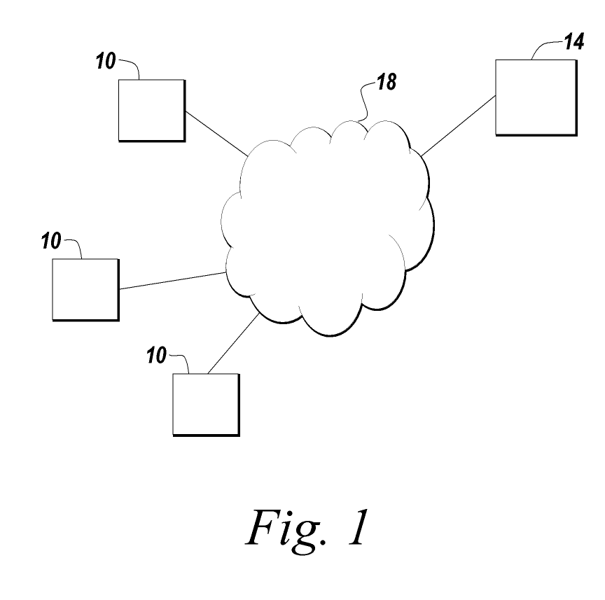

Referring now to FIG. 1, in brief overview, one embodiment of a client-server system in which the present invention may be used is depicted. One or more first computing systems (client node) 10 communicate with a second computing system (server node) 14 over a communications network 18. Although only one server node 18 is shown in FIG. 1, it should be understood that the client nodes 10 may communicate with one or more server nodes 18. In some embodiments one or more of the second computing systems is also a client node 10. The topology of the network 18 over which the client nodes 10 communicate with the server nodes 14 may be a bus, star, or ring topology. The network 18 can be a local area network (LAN), a metropolitan area network (MAN), or a wide area network (WAN) such as the Internet.

The client and server nodes 10, 14 can connect to the network 18 through a variety of connections including standard telephone lines, LAN or WAN links (e.g., T1, T3, 56 kb, X.25, SNA, DECNET), broadband connections (ISDN, Frame Relay, ATM, Gigabit Ethernet, Ethernet-over-SONET), and wireless connections. Connections can be established using a variety of communication protocols (e.g.,.TCP/IP, IPX, SPX, NetBIOS, Ethernet, ARCNET, Fiber Distributed Data Interface (FDDI), RS232, IEEE 802.11, IEEE 802.11a, IEEE 802.11b, IEEE 802.11g, and direct asynchronous connections). Other client nodes and server nodes (not shown) may also be connected to the network 18.

The client nodes 10 and server nodes 18 may be provided as any device capable of displaying video and otherwise capable of operating in accordance with the protocols disclosed herein, such as personal computers, windows-based terminals, network computers, information appliances, X-devices, workstations, mini computers, personal digital assistants or cell phones. Further, server nodes 18 may be provided as a group of server systems logically acting as a single server system, referred to herein as a server farm. In one embodiment, the server node 14 is a multi-user server system supporting multiple concurrently active client connections.

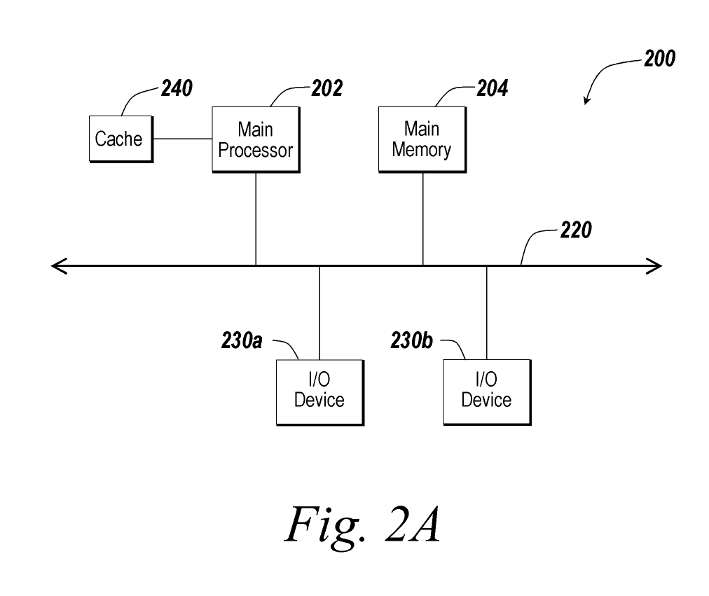

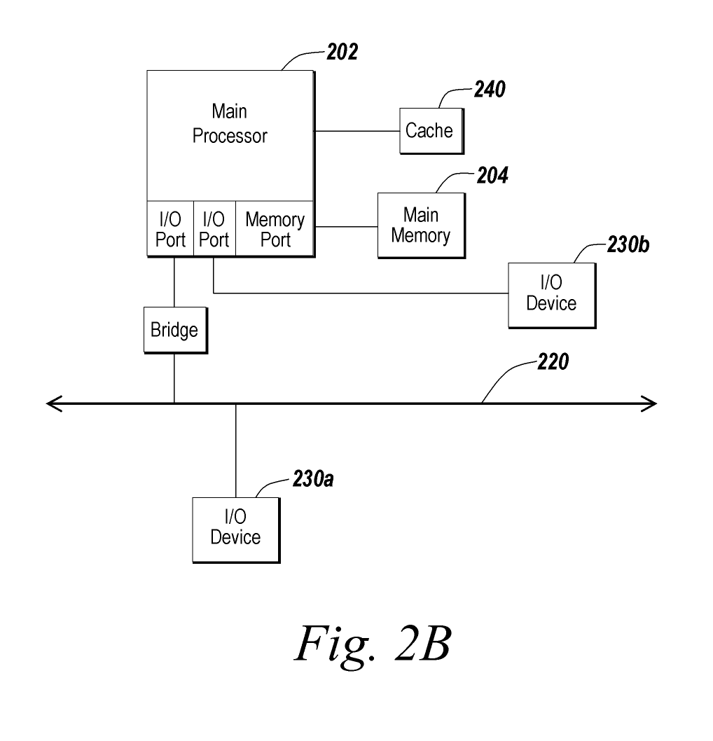

FIGS. 2A and 2B depict block diagrams of a typical computer 200 useful in the present invention. As shown in FIGS. 2A and 2B, each computer 200 includes a central processing unit 202, and a main memory unit 204. Each computer 200 may also include other optional elements, such as one or more input/output devices 230a-230b (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as: the 8088, the 80286, the 80386, the 80486, the Pentium, Pentium Pro, the Pentium II, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, the MPC7457 processor, all of which are manufactured by Motorola Corporation of Schaumburg, Ill.; the Crusoe TM5800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS 64 11, the P2SC, the POWER3, the RS64 III, the POWER 3-11, the RS 64 IV, the POWER4, the POWER4+, the POWER 5, or the POWER6 processor, all of which are manufactured by International Business Machines of White Plains, N.Y.; or the AMD Opteron, the AMD Athalon 64 FX, the AMD Athalon, or the AMD Duron processor, manufactured by Advanced Micro Devices of Sunnyvale, Calif.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). In the embodiment shown in FIG. 2A, the processor 202 communicates with main memory 204 via a system bus 220 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 220. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 220. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is an video display, the processor 202 may use an Advanced Graphics Port (AGP) to communicate with the display. FIG. 2B depicts an embodiment of a computer system 200 in which the main processor 202 communicates directly with I/O device 230b via Hyper-Transport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 200 such as one or more hard disk drives, redundant arrays of independent disks, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 230 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIGS. 2A and 2B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

In other embodiments, the client node 10 may have different processors, operating systems, and input devices consistent with the device. For example, in one embodiment the client node is a Zire 71 personal digital assistant manufactured by Palm, Inc. In this embodiment, the Zire 71 operated under the control of the PalmOS operating system and includes a stylus input device as well as a five-way navigator device.

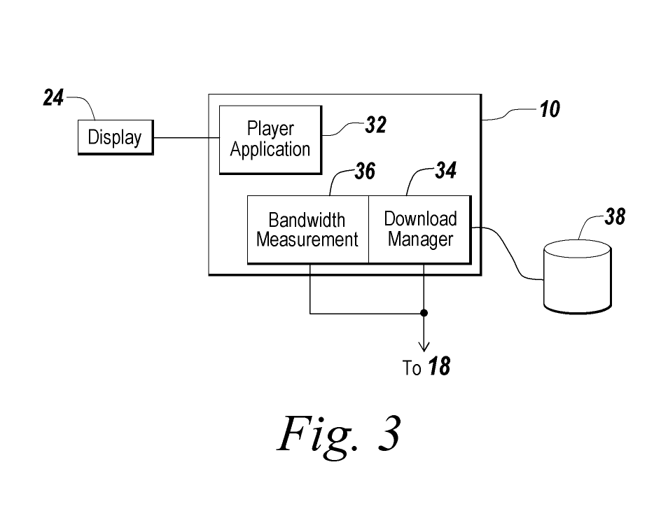

FIG. 3 depicts one embodiment of a client node 10 useful in connection with the present invention. The embodiment depicted in FIG. 3 includes a player application 32, a download manager 34, and a bandwidth measurement device 36. The player application 32, the download manager 34, and the bandwidth measurement device 36 may be provided as software applications permanently stored on a hard disk drive 38 and moved to main memory 204 for execution by the central processor 202. Alternatively, the player application 32 and the download manager 34 may be downloaded to the client node 10 from a server node 14 for execution by the central processor 202 of the client node 10.

Although FIG. 3 depicts the player application 32, download manager 34, and bandwidth measurement device 36 as separate entities they may be combined in any number of configurations. For example, in one embodiment, the download manager 34 and the bandwidth measurement device 36 may comprise the same corpus of executable code and may execute in the same thread process. Other possible combinations include the combination of the player application 32 with the download manager 34, the combination of the player application 32 with the bandwidth measurement device 36, or the combination of all three modules together. In any of these embodiments, the player application 32, the download manager 34 and the bandwidth measurement device 36 may be written in any one of a number of suitable programming languages, such a PASCAL, C, C+, C++, C#, or JAVA. In certain embodiments the player application 32, download manager 34, and bandwidth measurement device 36 may be provided to the user as computer-readable program means embodied on articles of manufacture including, but not limited to, magnetic media such as hard disks, floppy disks, and magnetic tape; optical media such as CD-ROMs, CD-R/RW discs, DVD-ROMs, DVD-RAMs, and holographic devices; magneto-optical media such as floptical disks; solid-state memories such as flash memory cards, flash drives, memory sticks, xD cards, MultiMedia cards, Smart Media cards, and USB storage devices; and hardware devices that are specially configured to store and execute program code, such as application-specific integrated circuits (“ASICs”), field-programmable gate arrays (FPGAs), programmable logic devices (“PLDs”), read only memories (“ROMs”), random access memories (“RAMs”), programmable array logics (PALs), programmable ROMs (“PROMs”), erasable programmable read only memories (“EPROMs”), and electrically erasable programmable read only memories (“EEPROMs”).

In other embodiments, the player application 32, the download manager 34, and the bandwidth determination device 36 may be provided as special-purpose hardware units dedicated to their respective functions. In these embodiments, the player application 32, the download manager 34, and the bandwidth determination device 36 may be provided as application-specific integrated circuits (ASICs), field-programmable gate arrays (FPGAs), programmable-logic devices (PLDs), programmable read-only memories (PROMs), or electrically-erasable programmable read-only memory (EEPROMs).

The download manager 34 downloads and stores locally content to be displayed by the player application 32. Although downloaded data may be stored in any form of persistent storage such as tape media, compact disc media, or floppy disk media, it is preferred that the download manager store downloaded data on a hard drive associated with the client node 10. In some embodiments, the download manager stores data on a redundant array of independent disks (RAID). In other embodiments, the download manager 34 stores data on a network storage device. The player application 32 retrieves locally store content and displays it. In this context, display refers to any production of physical phenomenon that is capable of being sensed, for example, video, audio, or tactile sensation.

The bandwidth measurement device 36 communicates with the download manager 34 and measures the bandwidth of the network connection over which a content file is downloaded. In one embodiment, the bandwidth measurement device 36 issues “ping” commands over the network connection to a server node 14 hosting content. As is known in the art, responses to “ping” commands typically include a data value representing the amount of time taken by the command to make a round-trip traversal of the network. Since bandwidth is a measure of the number of bytes that can be transmitted in a given time period, the bandwidth measurement device 36 can use the “ping” response to calculate the bandwidth of the network connection. In some of these embodiments the bandwidth measurement device 36 calculates the bandwidth of a network connection only at the beginning of a data transfer. In other embodiments, the bandwidth measurement device 36 determines network connection bandwidth dynamically during the transfer by issuing “ping” commands periodically during the data transfer.

For embodiments in which the bandwidth measurement device 36 measures network connection bandwidth only at the beginning of a transfer, the bandwidth measurement device 36 may issue a single “ping” command to determine network connection bandwidth or multiple “ping” commands and use an average of the “ping” responses to determine network connection bandwidth. In these latter embodiments, the number of “ping” commands issued is a sufficient number to determine bandwidth accurately without incurring too much connection setup overhead, e.g., three, five, seven, eight, or nine “ping” commands. When several “ping” commands are issued, the bandwidth measurement device may drop the fastest and slowest “ping” responses and average the remaining values to determine the network connection bandwidth.

For embodiments in which the bandwidth measurement device 36 measures network connection bandwidth dynamically during the data transfer by periodically issuing “ping” commands, the bandwidth measurement device 36 may use a rolling average of “ping” responses received to determine the bandwidth of the network connection. In others of these embodiments, the bandwidth measurement device 36 may use only the last “ping” response received to determine the bandwidth of the network connection. The periodicity with which the bandwidth measurement device 36 issues “ping” commands during the data transfer is selected to allow responsive adjustment of the network connection bandwidth determination without having a deleterious effect on the data transfer. “Ping” commands may be transmitted on the order of microseconds, milliseconds, tenths of seconds, or seconds.

In another embodiment, the bandwidth measurement device 36 includes a timer. In this embodiment, the timer is reset at the beginning of a data transfer. The download manager 34 notifies the bandwidth measurement device 36 of the total size of the data transfer and apprises, either continually or periodically, the bandwidth measurement device 36 of the amount of data downloaded. In these embodiments, the bandwidth measurement device 36 uses the timer data value, the total size of the data transfer, and the current progress of the data transfer to determine when the download manager 34 has downloaded a sufficient portion of a content file such that the download manager 34 would be able to download the remainder of the data file before the player application 32 finishes playing the locally stored portion. An example of this follows.

The download manager 34 determines that it should download a 21 MB video file that requires 4 minutes to play back in full. After downloading the file for 5 seconds, the bandwidth measurement device 36 informs the download load manager 34 that it has downloaded 375 kB of the file. In some embodiments, the download manager 34 requests this information from the bandwidth measurement device. In other embodiments, the bandwidth measurement device 36 pushes the information to the download manager 34. In some of these other embodiments, the bandwidth measurement device 36 continually makes available to the download manager 34 information regarding the file transfer.

From the information regarding the file transfer, the download manager 34 can determine that it downloaded at an average rate of 75 KB/sec (bytesDownloaded/downloadTime). If the download manager 34 assumes that the download rate will remain constant, it can determine that the remainder of the file (20.625 MB) will finish downloading in 4 minutes and 35 seconds ((videoLength−amountDownloaded)/downloadRate). In some embodiments these determinations are made by the bandwidth measurement device 36 and transmitted to the download manager 34.

The download manager 34 now determines if it has downloaded enough of the content file. That is, the download manager 34 must determine that if the user started displaying the content file, it could download the rest of the content file in time it would take for the locally-stored portion of the content file to be displayed. In this example, the video is 4 minutes long. Since the download manager 34 (or the bandwidth measurement device 36) has determined that the remainder of the video will take 4 minutes and 35 seconds to download, the download manager will continue downloading for approximately 35 additional seconds.

As the download proceeds, the system continues to sample the download rate and recalculates the remaining download time. If the download rate remains constant, after 40 additional seconds of download, the download manager 34 will have downloaded 3 MB of the file. At this point, the download manager 34 (or, in some embodiments, the bandwidth measurement device 36) determines that if the user were to begin displaying the content file, the remainder of the content file would finish downloading before the end of the content file is reached by the display manager, thereby insuring that no interruption of the content file display will be encountered. At this point, the download manager 34 can terminate the download of the content file and save the 3 MB it has already downloaded.

If the user selects the content file for display, the download manager 34 can download the remaining 18 MB of the content file while displaying the 3 MB of the file that is stored locally. If, however, the user never selects the content file for display, then the download manager 34 will have only downloaded 3 MB, saving 18 MB in bandwidth costs.

Before beginning a detailed discussion of the process used to download content, a brief introduction of the terms used in this document to identify various forms of content will be helpful. The terms introduced here are: channel; program; shelf; bundle; and content file.

A “channel” refers to an HTML application, e.g. a downloadable “mini web site,” that acts as the “player” for its programs. Channels may be thought of as “mini applications” or “custom players” for “programs,” which are described below. Both channels and programs are represented as directory structures containing content files, similar to the way a web site is structured as a hierarchy of directories and files. When the download manager 34 downloads a channel or program, it downloads a complete directory structure of files. A channel is also the object that owns programs, so if a channel is removed, its corresponding programs are also removed. Every channel is identified by a unique identifier referred to herein as an entityURI. The download manager 34 is made aware of channels when the channel's entityURI is passed through an API call made by an ActiveX object, which can be invoked by JavaScript in a web page. A channel also has an associated object that represents the contents of a version of the channel. During the download of an update to the channel, a new channel version object is created to represent the version of the channel being downloaded. When the new version is completely downloaded, the current channel version object is deleted and the new channel version object becomes the current channel version object. The channel version object includes a version number that is assigned by the source of the channel and is returned in response to a request for information about the channel made by the download manager 34. When the channel source returns a channel version object having a higher version number than the one currently stored by the download manager 34, it indicates to the download manager 34 that a new version of the channel is available for download. The download manager 34 creates a new channel version object and begins to download the new version of the channel.

A “program” is similar in structure to a channel. Like a channel, a program has a version number maintained by its source and the download manager 34 can begin downloading a new version of the program if it detects that the program's version number has increased. Like channels, programs are identified for download through ActiveX API calls. However, these API calls are usually made by the channel itself. A program is associated with a single channel. If the associated channel is removed from the client node 10, the program is removed as well.

As used herein, a “shelf” refers to subdivisions of the programs associated with a channel. When a program is downloaded, the download manager 34 may add the program to a specific shelf of a channel. Shelves represent a level of indirection between channels and programs, i.e., a channel doesn't own programs, instead a channel owns shelves, and the shelves own programs. Shelves are created and removed using ActiveX API's. Every channel has a “default shelf” which is created when the channel is added. In some embodiments, shelves are used to implement different rules for saving programs. For example, programs associated with one shelf may be deleted after one day, while programs associated with another shelf may be saved until the user explicitly deletes them.

As used in this document a “bundle” refers to a virtual directory structure that maps directory names, e.g., “images/ logo.gif,” to content files. The mapping is stored as XML in a content file. The content file storing the mapping is referred to as the bundle's descriptor. A bundle can be used in one of four ways: (1) as a synopsis bundle of a program; (2) as a content bundle of a program; (3) as the synopsis bundle of a channel; (4) or as the content bundle of a channel. In every case, a bundle is associated with either a program or a channel and may be stored in a respective program version object or channel version object.

As used in this document, a “content bundle” refers to a set of content files grouped into a virtual directory structure. A content bundle identifies the bulk of the channel or program content, and may be thought of as “the channel” or “the program.” The content bundle identifies each content file identified by the channel and indicates where that file is located in the virtual directory structure. One embodiment of a content bundle is shown below:
index.html==>
http: //www.content.com/contentAuthority#7291332
images/logo.gif==>
http://www.content.com/contentAuthority#15930531
images/spacer.gif==>
http://www.content.com/contentAuthority#9399203

The left hand side of each mapping is the name of the file within the content bundle's virtual directory structure. The right hand side of each mapping is the entityURI of a corresponding content file representing a single version of any particular item of content, e.g., an HTML file, an image, a video, etc. If a content file is changed, it is represented as a new content file with a new globally-unique entityURI. Thus, if a content file contained in a channel changes, a completely new content file is reissued and the appropriate content bundle is modified to “point” to the new content file.

As used herein, a content file represents one of the content file entities described above. It keeps track of the URL for getting an actual file, where the file is on the local disk, and how much of the file has been downloaded. Content files are referenced by bundles. Because content files can be shared between channels and programs, a content file might be referenced by more than one bundle. Alternatively, a content file might not be referenced by bundles. For example, in some embodiments when a program is deleted, its content files are not deleted at the same time. This is advantageous in embodiments in which other programs include the same content file. Content files include traditional forms of content, such as video and audio, as well as interactive elements to be displayed to the user. For example, a content file may store an interactive element that offers for sale products or services related to other content in the channel. A specific example of this is video from a magazine source, such as National Geographic or Time Magazine, having an interactive element soliciting magazine subscriptions displayed semi-transparently over the running video.

The three basic elements of the content distribution system: channels; programs; and content files, are referred to herein as entities. Each entity has a globally-unique entityURI, which both uniquely identifies the entity and contains enough information to locate the entity. In one embodiment, an entityURI has the following format:
http: //www.mycompany.com/contentAuthority#33958193020193

In this embodiment, the entityURI includes a content source Uniform Resource Locator address (URL), i.e., http://www.mycompany.com/contentAuthority, and an identification code identifying the file, i.e., #33958193020193. In some embodiments, the entityURI is not human-readable. In some embodiments, the entityURI is a URL, i.e., it does not include the “#” symbol separating the identification code from the remainder of the entityURI. In these embodiments, the entityURI may be represented in the following manner:
http://www.mycompany.com/contentAuthority/33958193020193. Still further embodiments may include a mixture of both forms of entityURls.

Although there are several utilities that can represent a directory of files in a single file making it easy to transport an entire directory of files—ZIP files are widely used in personal computers running a WINDOWS-based operating system and .TAR files are often used on computers running a UNIX-based operating system—this approach is not used in the present invention for two reasons. First, it is possible that several channels or programs will share the same files, for example, multiple programs might all include the same advertisement. Downloading this content multiple times would consume additional time and bandwidth. The second reason for avoiding this approach is that channels and programs may be updated often, sometimes with minor changes. In these cases, the download cost can be minimized by only transporting those files that have changed, without having to transport an entire .ZIP or .TAR file.

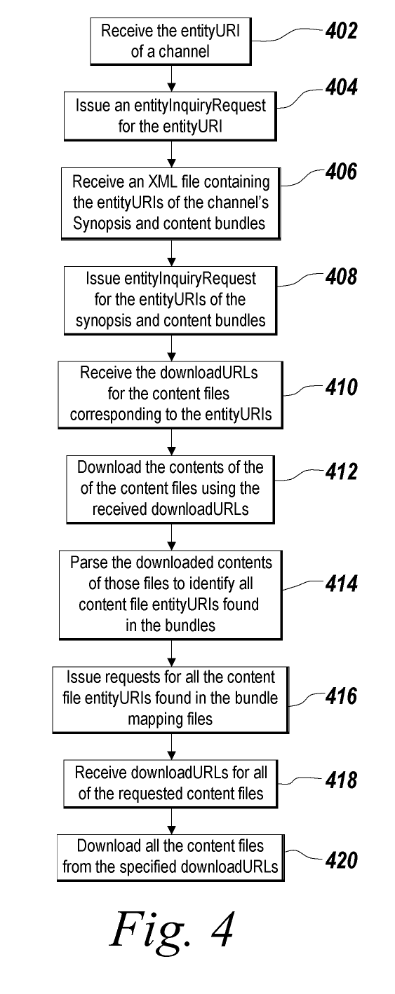

FIG. 4 depicts the steps taken by the download manager 34 to download a channel of content. In brief overview, the process for downloading a channel includes the steps of: receiving the entityURI of a channel (step 402); issuing a request for information about the entityURI (step 404);

receiving an XML file containing the entityURls of the channel's synopsis and content bundles (step 406); issuing requests for information about the entityURls of the synopsis and content bundles; (step 408); receiving an XML file containing the entityURls for the synopsis and content bundles (step 410); downloading the contents of the files identified by the received entityURls for the synopsis and content bundles (step 412); parsing the downloaded contents of those files to identify all content file entityURls found in the bundles (step 414); issuing requests for all the content file entityURls found in the bundle mapping files (step 416); receiving downloadURLs for all of the requested content files (step 418); and downloading all the content files from the specified download-URLs (step 420).

Still referring to FIG. 4, and in more detail, the process for downloading a channel begins by receiving the entityURI of a channel (step 402). An exemplary channel entityURI is reproduced below:
http://theartist.tld.net/contentAuthority/channels/TheArtistJukebox

In some embodiments, the entityURI is “pushed” to the download manager 34 by a server node 14. For example, a user of a client node 10 may access a web site that makes a JavaScript call to a function exposed by the download manager 34. That function call passes the entityURI of the channel to be downloaded. In other embodiments, the entityURI may be “pulled” by the client node 10 by, for example, clicking on a hyperlink that delivers to the download manager 34 the entityURI. In still other embodiments the download manager 34 may retrieve entityURIs from an article of manufacture, such as a CD-ROM or DVD-ROM, having the entityURls embodied thereon.

Once the download manager 34 has the entityURI of a channel, it issues a request for more information about the entityURI of the channel (step 404). Using the exemplary channel entityURI reproduced above, the download manager would issue an HTTP GET request to http://theartist.tld.net/contentAuthority/channels/TheArtistJukebox. In some embodiments, this request is made via an HTTP POST request to the content source identified in the entityURI, i.e., http://www.mycompany.com/contentAuthority. In some of these embodiments, the HTTP POST request includes an XML document including additional information about the request.

Upon receipt of the request, the download manager 34 receives information about the channel transmitted by the content source (step 406). In some embodiments, the content source transmits an XML file to the download manager 34. An exemplary XML received by the download manager in these embodiments is:

<contentAuthorityResponse
xmlns=“http://www.tld.net/xml/ns/ContentAuthorityRes
ponse”>
<channelInfo
enti-
tyURI=“http://theartist.tld.net/contentAuthority/channels
/TheArtistJukebox/channelEntity.xml”
synopsis-
BundleURI=“http://theartist.tld.net/contentAuthority/Ba5
3de4cf68c7cd995cD7c9910d1d1d45.xml”
content-
BundleURI=“http://theartist.tld.net/contentAuthority/Ba5
3de4cf68c7cd995cD7c9810d1d1d45.xml”
version=“1058919065331”
/>
</contentAuthorityResponse>

The first field identifies the file as a response to the HTTP GET request issued by the download manager 34. In the example above, the information transmitted to the download manager 34 includes an identification of the entityURI, a “synopsis” of the channel (the synopsisBundleURI) and a content bundle (the contentBundleURI). The example reproduced above includes an identification of the current version of the channel, i.e. version=1058919065331. In some embodiments, the synopsis includes a very small amount of information, such as meta-data describing the channel or, in some embodiments, a “teaser” image. Because the synopsis is small, a download manager 34 is able to load this information very quickly.

This allows a client node to display information about a channel immediately without waiting to download the content for a channel, which is usually much larger than the synopsis and, therefore, takes longer to download.

The download manager 34 requests more information about the entityURl of the content bundle and the entityURI of the synopsis bundle (step 408). In some embodiments the client node issues these requests as HTTP POST requests. For example, to retrieve information relating to the synopsis bundle, the download manager 34 may issue an HTTP GET request to http://theartist.tld.net/contentAuthority/Ba53de4cf68c7c d995cD7c9910d1d1d45.xml. A similar process is followed for the content bundle. The download manager 34 may issue the requests serially, or it may issue several requests for information in a single HTTP POST request. For embodiments in which the entityURI is a URL (such as in the example above), the download manager 34 issues an HTTP GET request instead of an HTTP POST request. In these embodiments, only a single request is issued at a time. The XML files for the synopsis and the content bundle do not need to be stored on the same server node 14. Thus, in some embodiments, a “synopsis server” and a “content server” may be used to implement the present invention.

In response to the requests, the client node 10 receives information about the synopsis and content files of a particular channel (step 410). An example of the response transmitted to the client node 10 in response to a request for information relating to the content bundle is reproduced below:

<contentAuthorityResponse
xmlns=“http://www.tld.net/xml/ns/ContentAuthorityRes
ponse”>
<contentFileInfo
enti-
tyURI=“http://theartist.tld.net/contentAuthority/Ba53de4
cf68c7cd995cD7c9810d1d1d45.xml”
download-
URL=“http://theartist.tld.net/content/channel/Ba53de4cf
68c7cd995cD7c9810d1d1d45.xml.bnd.xml”
/>
</contentAuthorityResponse>

The downloadURL, i.e., http://theartist.tld.net/content/channel/Ba53de4cf68c7c d995cD7c9810d1d1d45.xml.bnd.xml, indicates from where the client node 10 can download the bundle's descriptor. In some embodiments, the content source may choose downloadURLs based on load, physical location, network traffic, affiliations with download sources, etc. In some embodiments, the server node 14 responds with URL addresses identifying files for the download manager 34 to download. In some embodiments, the server node 14 uses a “prefetch” algorithm to transmit to the download manager 34 information about related entityURls about which the server node 14 predicts the download manager 34 will request information in the future.

The download manager 34 then downloads the bundle descriptor (step 412). In the example being followed, the download manager receives:

<bundle xmlns=“http://www.tld.net/xml/ns/Bundle”>
<contentFile enti-
tyURI=“http://theartist.tld.net/contentAuthority//La53de4
cf68c7cd995cD7cb710d1d1d45.xml”
name=“images/wave.jpg” />
<contentFile enti-
tyURI=“http://theartist.tld.net/contentAuthority/La53de4c
f68c7cd995cD7cb810d1d1d45.xml”
name=“logos/labelLogo.gif” />
<contentFile enti-
tyURI=“http://theartist.tld.net/contentAuthority/La53de4c
f68c7cd995cD7cb910d1d1d45.xml”
name=“images/top.gif” />
<contentFile enti-
tyURI=“http://theartist.tld.net/contentAuthority/La53de4c
f68c7cd995cD7cba10d1d1d45.xml” name=“register.js” /
>
<contentFile enti-
tyURI=“http://theartist.tld.net/contentAuthority/La53de4c
f68c7cd995cD7cbb10d1d1d45.xml”
name=“register.html” />
<contentFile enti-
tyURI=“http://theartist.tld.net/contentAuthority/La53de4c
f68c7cd995cD7cbc10d1d1d45.xml”
name=“playMenu.xsl” />
...
</bundle>

As described above, and as shown in the example above, a bundle file is an XML file mapping files in a virtual file structure to physical addresses at which the file can be located. The download manager 34 parses the received files to identify all content files required for a channel (step 414). The download manager 34 determines if it has already downloaded any of the identified files. In some embodiments it does this by comparing the entityURl of each identified file with the entityURl of each file the download manager 34 has already downloaded and stored locally.

For each file identified in the bundle that the download manager 34 has not already retrieved, the download manager 34 issues requests more information about each of the files identified (step 416). In some embodiments, these requests are HTTP POST requests. For example, in the example above, the download manager 34 issues an HTTP GET request to http://theartist.tld.net/contentAuthority/La53de4cf68c7c d995cD7cb710d1d1d45.xml to retrieve information about a file that will appear as images/wave.jpg in the virtual file structure the download manager 34 is creating. The content authority responds with information about the file, such as the file type, file size, and URL from which it can be downloaded. This allows the content source to direct the download manager 34 the best source for the content file. In some embodiments, the content source may direct the download manager 34 to another client node 10 instead of to a server node 14.

In response to its requests for more information, the download manager 34 receives information about all of the requested files (step 418). An exemplary response to that request has the following form:

<contentAuthorityResponse
xmlns=“http://www.tld.net/xml/ns/ContentAuthorityRes
ponse”>
<contentFileInfo
enti-
tyURI=“http://theartist.tld.net/contentAuthority/Tld.net/L
a53de4cf68c7cd995cD7cb710d1d1d45.xml”
download-
URL=“http://theartist.tld.net/fcs/static/networks/tld.net/
publishers/TheArtistJuke-
box/channelEntity/content/wave.jpg”
/>
</contentAuthorityResponse>

This response directs the download manager 34 to download the file wave.jpg from http://theartist.tld.net/fcs/static/networks/tld.net/publishers/ TheArtistjukebox/channelEntity/content/wave.jpg. The download manager 34 downloads the identified content files (step 420). In some embodiments, the download manager 34 issues one or more HTTP GET calls to download the file's contents. The download manager 34 may keep track of how much of the file has been downloaded, so that if it gets interrupted (a common occurrence when downloading large files), it can resume the download at the point it was interrupted. Once downloaded, the download manager 34 will store the file locally at the client node 10. The download manager 34 retrieves any files that have not already been downloaded and stores them locally. This approach allows a content file to be downloaded only once, but shared by multiple channels and programs on the client node 10. It also allows each individual client to determine which new content files it should download for new versions of channels and programs.

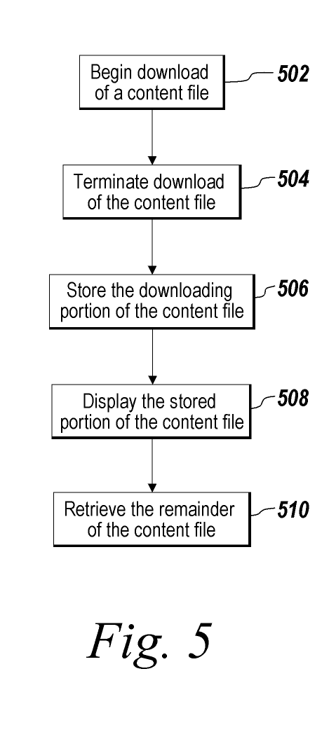

FIG. 5 depicts one embodiment of steps taken to efficiently download data, that is, FIG. 5 depicts steps that may be used in place of step 420 in FIG. 4. In brief overview, one embodiment of steps to be taken to efficiently download content includes: beginning download of a content file (step 502); terminating download of the content file (step 504); storing the downloading portion of the content file (step 506); displaying the stored portion of the content file (step 508); and retrieving the remainder of the content file in response to the display of the stored portion of the content file (step 510).

Still referring to FIG. 5, and in greater detail, download of a content file is begun (step 502) as described above in connection with FIG. 4. The steps for efficiently downloading a content file that are about to be described may be applied to each content file identified in a bundle mapping file. Alternatively, they may be applied only to certain files, such as video files identified by a bundle mapping file.

Download of the content file is terminated (step 504). For embodiments in which the bandwidth determination device 36 is implemented separately from the download manager 34, termination occurs in response to a signal sent from the bandwidth determination device 36. The download manager 34 can, at this point, store the position in the content file at which the download was terminated in the bundle mapping files. Alternatively, the download manager may create and administer a file that maps each content file included in a channel with the amount of that file that has been downloaded. The portion of the content file that is retrieved is stored locally (step 506) as described above in connection with FIG. 4.

The stored portion of the content file is displayed (step 508), generally in response to user input indicating that the file should be displayed. In some embodiments, however, content files are displayed (step 508) in response to automated or scheduled processes such as, for example, “cron” jobs on a UNIX or LINUX-based machine.

In response to the initiation of content file display, the download manager 34 retrieves the remainder of the content file (step 510). The download manager 34 may reinitiate download of the content file at the proper position by referring to a data value stored in the bundle mapping files or another file, as described above. Alternatively, the player application 32 may transmit to the download manager 34 an indication of the file it is preparing to download and the current size of the file. The download manager may use that indication to begin download of the content file beginning at the proper position.

The remainder of the content file is downloaded, stored locally, and displayed, as described above.

Referring back to FIG. 3, in another embodiment of a client node 10 useful in connection with the present invention, no bandwidth measurement device 36 is provided. In these embodiments, the download manager 34 downloads a predetermined amount of the content file before terminating the file transfer. For example, the download manager may always download half the file before stopping. In other embodiments, the download manager 34 downloads a constant amount of each file, foe example, 1 MB of each content file encountered. In still other embodiments, the amount to be downloaded may be user-specified. In some of these other embodiments, the amount to be downloaded may be specified on a file-by-file basis. In still other embodiments, the client node may include a bandwidth measurement device 36 and the user may specify whether to engage the bandwidth measurement device 36 or whether to download a predetermined or constant amount of each file.

Still referring to FIG. 3, the player application 32 displays media content at the client node 10. The player application displays video on a display 24. The player application 32 displays channels, provides channels with the ability to display video, and provides the user with access to the state of the files downloaded for each channel, i.e., the list of programs and their channels, the respective download states of each file, and other options associated with the files. The player application 32 also displays common user interface elements for all channels. Some examples of common user interface elements include a file management tool tab, a “my channels” tool tab, a recommendation tool tab, and a program information tool tab.

The file management tool tab provides information to the user concerning the channels and programs that have been downloaded to the client node 10, together with the state of the download.

The “my channels” tool tab provides information regarding the list of channels to which the user has subscribed. In some embodiments, this tool tab allows the user to click on a channel to begin display of that channel.

The recommendation tool tab displays a window to the user that allows the user to recommend the currently-playing program to a friend. Recommendations may be sent by e-mail or an instant messaging system. For embodiments in which email is sent, the email may contain a JavaScript that automatically installs the download manager 34 and player application 32 on the friend's computer, subscribe the friend to the channel, and start downloading content for the channel.

The program information tool tab displays to the user information about the currently-playing program. In some embodiments, this information is taken directly from the synopsis bundle of the program.

Since a channel is an HTML application, a channel is free to use any ActiveX control or other media player application to display content, such as Windows Media Player manufactured by Microsoft Corp. of Redmond, Wash., or Real Player manufactured by Real Networks, Inc. of Seattle, Wash. For the purposes of the present invention it is preferred to use an “off-the-shelf” media player, such as Windows Media Player, Real Player, or the Quicktime Player manufactured by Apple Computer of Cupertino, Calif.

While the invention has been shown and described with reference to specific preferred embodiments, it should be understood by those skilled in the art that various changes in form and detail may be made therein without departing from the spirit and scope of the invention as defined by the following claims.

1. A client system for efficiently downloading a page of broadband content including at least one content file, the client system comprising:
a mass storage device;
a bandwidth measurement device determining the bandwidth of a network connection over which a content file is downloaded;
a download manager retrieving and storing in the mass storage device a portion of the content file, the size of the portion of the content file responsive to the determination made by the bandwidth measurement device; and
a presentation manager retrieving the portion of the content file from mass storage and displaying the portion with a standard media player application,
wherein the download manager downloads the remainder of the content file in response to the presentation manager displaying the portion of the second content file.

2. The client system of claim 1 wherein the mass storage device comprises a redundant array of independent disks.

3. The client system of claim 1 wherein the mass storage device comprises a network storage solution.

4. The client system of claim 1 wherein the bandwidth measurement device comprises a timer.

5. The client system of claim 1 wherein the bandwidth measurement device and the download manager comprise a single process.

6. The client system of claim 1 wherein the download manager comprises a thread process.

7. The client system of claim 1 wherein the download manager comprises one of the group consisting of an ActiveX control and a JAVA applet.

8. The client system of claim 1 wherein the presentation manager comprises a threaded process.

9. The client system of claim 1 wherein the presentation manager comprises a Windows Media Player application.

10. A method for efficiently downloading a page of broadband content including at least one content file, the method comprising the steps of:
(a) retrieving a content file;
(b) terminating retrieval of the content file before the entire content file is retrieved;
(c) storing the retrieved portion of the content file in a mass storage device;
(d) reading the portion of the content file from the mass storage device;
(e) displaying with a standard media player application the read portion of the content file; and
(f) retrieving, in response to step (e), the remainder of the content file.

11. The method of claim 10 wherein step (b) comprises:
(b-a) determining the bandwidth of a network connection over which the content file is retrieved; and
(b-b) terminating retrieval of the content file before the entire content file is retrieved, the termination responsive to the bandwidth determination made in step (b-a).

12. The method of claim 10 wherein step (a) comprises retrieving from a peer-to-peer network a content file.

13. The method of claim 10 wherein step (a) comprises retrieving from a multicast network a content file.

14. The method of claim 10 wherein step (f) comprises retrieving, in response to step (e), the remainder of the content file from a peer-to-peer network.

15. The method of claim 10 wherein step (f) comprises retrieving, in response to step (e), the remainder of the content file from a multicast network.

16. The method of claim 10 further comprising the step of displaying with a standard media player application the remainder of the content file.

17. The method of claim 10 wherein step (e) and step (f) occur substantially concurrently.

18. An article of manufacture having embodied thereon computer-readable program means for efficiently downloading a page of broadband content including a first content file and a second content file, the article of manufacture comprising:
computer-readable program means for retrieving a content file;
computer-readable program means for terminating retrieval of the content file before the entire content file is retrieved;
computer-readable program means for storing the retrieved portion of the content file in a mass storage device;
computer-readable program means for reading the portion of the content file from the mass storage device;
computer-readable program means for displaying with a standard media player application the read portion of the content file; and
computer-readable program means for retrieving the remainder of the content file.
